(19) United States
(12) Patent Application Publication
(10) Pub. No.: US 2025/0182455 A1
(43) Pub. Date: Jun. 5, 2025

(54) VIDEO TIME-EFFECTIVENESS CLASSIFICATION MODEL TRAINING METHOD AND VIDEO TIME-EFFECTIVENESS CLASSIFICATION METHOD

(71) Applicant: Tencent Technology (Shenzhen) Company Limited, Shenzhen (CN)

(72) Inventors: Weijie Kong, Shenzhen (CN); Chengfei Cai, Shenzhen (CN); Wenzhe Zhao, Shenzhen (CN); Bo Cui, Shenzhen (CN); Jiangfeng Xiong, Shenzhen (CN); Hongfa Wang, Shenzhen (CN); Wei Liu, Shenzhen (CN)

(73) Assignee: Tencent Technology (Shenzhen) Company Limited, Shenzhen (CN)

(21) Appl. No.: 19/047,875

(22) Filed: Feb. 7, 2025

Related U.S. Application Data
(63) Continuation of application No. PCT/CN2023/130920, filed on Nov. 10, 2023.

(30) Foreign Application Priority Data
Feb. 9, 2023 (CN) 202310137813.4

(51) Int. Cl. G06V 10/774; G06V 10/764; G06V 10/82; G06V 20/40; G06V 30/18; G06V 30/19; G10L 25/57

(52) U.S. Cl. CPC G06V 10/774; G06V 10/764; G06V 10/82; G06V 20/41; G06V 20/46; G06V 30/1801; G06V 30/19173; G10L 25/57

(57) ABSTRACT

A training method for a video time-effectiveness classification model, performed by a computer device, includes obtaining video samples; extracting, from the video samples, sample image frames, first text information, and time-effectiveness sensitivity information; extracting image features from the sample image frames, text features from the first text information, and time-effectiveness sensitivity features of the time-effectiveness sensitivity information; and generating a trained video time-effectiveness classification model from an untrained neural network model by training the neural network model based on the image features, the text features, and the time-effectiveness sensitivity features, wherein the trained video time-effectiveness classification model may be configured to receive a video sample as input and output a predicted effective life cycle classification result.

### CROSS-REFERENCE TO RELATED APPLICATIONS

This application is a continuation application of International Application No. PCT/CN2023/130920 filed on Nov. 10, 2023, which claims priority to Chinese Patent Application No. 202310137813.4, filed with the China National Intellectual Property Administration on Feb. 9, 2023, the disclosures of each being incorporated by reference herein in their entireties.

### FIELD

The disclosure relates to the field of depth learning technologies, and in particular, to a video time-effectiveness classification model training method, a video time-effectiveness classification method and apparatus, a computer device, a computer-readable storage medium, and a computer program product.

### BACKGROUND

With the rapid development of computer technologies, various video platforms are rapidly popularized, so that videos gradually become an important medium for people to learn about current hotspots, share personal life, and pass time for leisure. A video platform may push a video within an effective life cycle of the video, to ensure a pushing effect. The effective life cycle may represent time-effectiveness of the video.

In the related art, time-effectiveness classification is performed based on text information in a video, to obtain a time-effectiveness classification result of the video. When there are many noise words included in the text information, or there is little text information that can be extracted from the video, time-effectiveness classification of a video by using the method has a disadvantage of an inaccurate classification result.

### SUMMARY

Provided are a video time-effectiveness classification model training method, a video time-effectiveness classification method and apparatus, a computer device, a computer-readable storage medium, and a computer program product.

According to an aspect of the disclosure, a training method for a video time-effectiveness classification model, performed by a computer device, includes obtaining a plurality of video samples; extracting, from the plurality of video samples, a plurality of sample image frames, first text information, and time-effectiveness sensitivity information; extracting a plurality of image features from the plurality of sample image frames, a plurality of text features from the first text information, and a plurality of time-effectiveness sensitivity features of the time-effectiveness sensitivity information; and generating a trained video time-effectiveness classification model from an untrained neural network model by training the neural network model based on the plurality of image features, the plurality of text features, and the plurality of time-effectiveness sensitivity features, wherein the trained video time-effectiveness classification model may be configured to receive a video sample as input and output a predicted effective life cycle classification result.

According to an aspect of the disclosure, a training apparatus for a video time-effectiveness classification model, includes at least one memory configured to store computer program code; and at least one processor configured to read the program code and operate as instructed by the program code, the program code including video sample obtaining code configured to cause at least one of the at least one processor to obtain a plurality of video samples; sample information extraction code configured to cause at least one of the at least one processor to extract, from the plurality of video samples, a plurality of sample image frames, first text information, and time-effectiveness sensitivity information; feature extraction code configured to cause at least one of the at least one processor to extract a plurality of image features from the plurality of sample image frames, a plurality of text features from the first text information, and a plurality of time-effectiveness sensitivity features of the time-effectiveness sensitivity information; and model training code configured to cause at least one of the at least one processor to generate a trained video time-effectiveness classification model from an untrained neural network model by training the neural network model based on the plurality of image features, the plurality of text features, and the plurality of time-effectiveness sensitivity features, wherein the trained video time-effectiveness classification model may be configured to receive a video sample as input and output a predicted effective life cycle classification result.

According to an aspect of the disclosure, a non-transitory computer-readable storage medium, storing computer code which, when executed by at least one processor, causes the at least one processor to at least obtain a plurality of video samples; extract, from the plurality of video samples, a plurality of sample image frames, first text information, and time-effectiveness sensitivity information; extract a plurality of image features from the plurality of sample image frames, a plurality of text features from the first text information, and a plurality of time-effectiveness sensitivity features of the time-effectiveness sensitivity information; and generate a trained video time-effectiveness classification model from an untrained neural network model by training the neural network model based on the plurality of image features, the plurality of text features, and the plurality of time-effectiveness sensitivity features, wherein the trained video time-effectiveness classification model may be configured to receive a video sample as input and output a predicted effective life cycle classification result.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of a video time-effectiveness classification model training method and a video time-effectiveness classification method in some embodiments.

FIG. 2 is a schematic flowchart of a video time-effectiveness classification model training method in some embodiments.

FIG. 3 is a schematic diagram of a determination process of a sample image frame in some embodiments.

FIG. 4 is a schematic diagram of an extraction process of time-effectiveness sensitivity information in some embodiments.

FIG. 5 is a schematic diagram of a training process of a video time-effectiveness classification model in some embodiments.

FIG. 6 is a schematic flowchart of a video time-effectiveness classification model training method in some embodiments.

FIG. 7 is a schematic flowchart of a video time-effectiveness classification method in some embodiments.

FIG. 8 is a schematic diagram of a process of video time-effectiveness classification in some embodiments.

FIG. 9 is a block diagram of a structure of a video time-effectiveness classification model training apparatus in some embodiments.

FIG. 10 is a block diagram of a structure of a video time-effectiveness classification apparatus in some embodiments.

FIG. 11 is an internal structure diagram of a computer device in some embodiments.

FIG. 12 is an internal structure diagram of a computer device in some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

A video time-effectiveness classification model training method and a video time-effectiveness classification method provided in some embodiments may be based on artificial intelligence. For example, the video time-effectiveness classification model in some embodiments may be a neural network model. Solutions provided in some embodiments relate to technologies such as an artificial intelligence computer vision technology, a speech technology, and machine learning.

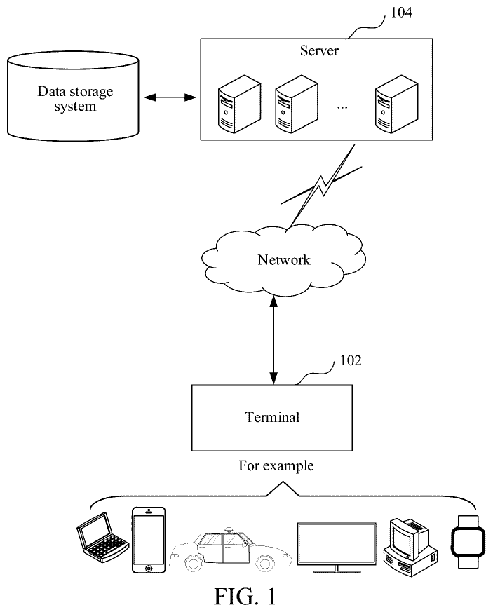

An image data processing method provided in some embodiments may be applied to an application environment as shown in FIG. 1. The application scene may include a terminal 102 and a server 104. The terminal 102 and the server 104 may communicate through a communication network. The communication network may be a wired network or a wireless network. The terminal 102 and the server 104 may be directly or indirectly connected in a wired or wireless communication mode. For example, the terminal 102 may be indirectly connected to the server 104 by using a wireless access point, or the terminal 102 may be directly connected to the server 104 by using the Internet. This is not limited.

The terminal 102 includes but is not limited to a mobile phone, a computer, an intelligent voice interaction device, a smart home appliance, an in-vehicle terminal, an aircraft, and the like. Some embodiments may be applied to a scene of video time-effectiveness classification, and may further be applied to a plurality of other scenes in which video information content is understood, including but not limited to various scenes such as cloud technologies, artificial intelligence, intelligent transportation, and assisted driving. A client related to video time-effectiveness classification may be installed on the terminal 102. The client may be software (such as a browser or video software), or may be a webpage, a mini program, or the like. The server 104 is a background server corresponding to software, a web page, a mini program, or the like, or is a server configured to perform video time-effectiveness classification. This is not limited. Further, the server 104 may be an independent physical server, or a server cluster or distributed system including a plurality of physical servers, or may be a cloud server providing cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. A data storage system may store data that may be processed by the server 104. The data storage system may be integrated on the server 104, or may be placed on a cloud or another server.

The video time-effectiveness classification model training method and the video time-effectiveness classification method in some embodiments may be separately performed by the terminal 102 or the server 104, or may be jointly performed by the terminal 102 and the server 104.

In some embodiments, the foregoing method may be jointly performed by the terminal 102 and the server 104. For example, the terminal 102 may obtain a plurality of video samples. For each video sample, a sample image frame, text information, and time-effectiveness sensitivity information are extracted from the video sample, and the sample image frame, the text information, and the time-effectiveness sensitivity information are transmitted to the server 104. Then, the server 104 extracts an image feature of the sample image frame, a text feature of the text information, and a time-effectiveness sensitivity feature of the time-effectiveness sensitivity information respectively. Model training is performed based on the respective image features, text features, and time-effectiveness sensitivity features of the video samples, to obtain a video time-effectiveness classification model for video time-effectiveness classification. After obtaining the video time-effectiveness classification model, the server 104 may further use the video time-effectiveness classification model to perform time-effectiveness classification on a to-be-classified video, and determine a time-effectiveness classification result of the to-be-classified video, so as to push a video having time-effectiveness to the terminal 102 based on the time-effectiveness classification result, thereby improving a video pushing effect.

In some embodiments, in a case that a data processing capability of the terminal 102 meets a data processing requirement, an application environment of the video time-effectiveness classification model training method and the video time-effectiveness classification method provided in some embodiments may involve only the terminal 102. The terminal 102 obtains a plurality of video samples, and performs model training based on the respective image features, text features, and time-effectiveness sensitivity features of the video samples, to obtain a video time-effectiveness classification model for video time-effectiveness classification. After obtaining the video time-effectiveness classification model, the terminal 102 may further use the video time-effectiveness classification model to perform time-effectiveness classification on a to-be-classified video, and determine a time-effectiveness classification result of the to-be-classified video. The to-be-classified video may be a video stored in a storage space of the terminal 102, so that the terminal 102 may delete a video that does not have time-effectiveness, to release the storage space.

In some embodiments, the server 104 may independently perform the foregoing method. In a training process of the video time-effectiveness classification model, the server 104 is configured to: obtain a plurality of video samples; extract, for each video sample, a sample image frame, text information, and time-effectiveness sensitivity information from the video sample; extract an image feature of the sample image frame, a text feature of the text information, and a time-effectiveness sensitivity feature of the time-effectiveness sensitivity information respectively; and perform model training based on the respective image features, text features, and time-effectiveness sensitivity features of the video samples, to obtain a video time-effectiveness classification model for video time-effectiveness classification. After obtaining the video time-effectiveness classification model, the server 104 may further use the video time-effectiveness classification model to perform time-effectiveness classification on a to-be-classified video, and determine a time-effectiveness classification result of the to-be-classified video, so as to push a video having time-effectiveness to the terminal 102 based on the time-effectiveness classification result, thereby improving a video pushing effect.

In some embodiments, the video time-effectiveness classification model training method and the video time-effectiveness classification method may be applied to a short video pushing scene. The server 104 may obtain a plurality of short video samples, and extract, for each short video sample, a sample image frame, text information, and time-effectiveness sensitivity information from the short video sample. The text information may include, for example, title text information, image text information, and audio text information. The time-effectiveness sensitivity information may include, for example, time-effectiveness sensitivity information in image information, audio information, and text information of the short video sample. Then, the server extracts an image feature of the sample image frame, a text feature of the text information, and a time-effectiveness sensitivity feature of the time-effectiveness sensitivity information respectively, and performs model training based on the respective image features, text features, and time-effectiveness sensitivity features of the short video samples, to obtain a video time-effectiveness classification model for video time-effectiveness classification. After obtaining the video time-effectiveness classification model, the server 104 obtains a to-be-classified short video. The to-be-classified short video may be, for example, a short video created and uploaded by a terminal user, or may be a short video generated by the server. Then, the server 104 extracts an image frame, text information, and time-effectiveness sensitivity information from the to-be-classified short video, performs time-effectiveness classification on the to-be-classified short video based on the extracted information by using a trained video time-effectiveness classification model, determines a time-effectiveness classification result of the to-be-classified short video, so as to determine an effective life cycle of the to-be-classified short video based on the time-effectiveness classification result, and further performs related processing, such as launch, removal, and push, on the short video according to the effective life cycle. For example, the server 104 may perform launch and push processing on a short video within an effective life cycle of the short video, and perform removal processing on the short video after the effective life cycle ends.

In some embodiments, the video time-effectiveness classification model training method and the video time-effectiveness classification method may be applied to a video search scene. The server 104 may obtain a plurality of video samples, and extract, for each video sample, a sample image frame, text information, and time-effectiveness sensitivity information from the video sample. Then, the server extracts an image feature of the sample image frame, a text feature of the text information, and a time-effectiveness sensitivity feature of the time-effectiveness sensitivity information respectively, and performs model training based on the respective image features, text features, and time-effectiveness sensitivity features of the video samples, to obtain a video time-effectiveness classification model for video time-effectiveness classification. After obtaining the video time-effectiveness classification model, the server 104 may perform time-effectiveness classification on a to-be-classified video by using the video time-effectiveness classification model, to determine a time-effectiveness classification result. In a case that the server 104 is configured to search for a video, the server may preferentially present, with reference to the time-effectiveness classification result of each video, a video that is related to a video search keyword and has a relatively short effective life cycle, to improve an exposure rate of a short-time-effectiveness video.

The following describes a video time-effectiveness classification model training method in some embodiments. As described above, the video time-effectiveness classification model training method may be applied to a server, or may be applied to a system including a terminal and a server, and is implemented through interaction between the terminal and the server. In some embodiments, if a data processing capability of the terminal meets a data processing requirement of a model training process, the video time-effectiveness classification model training method may be applied to the terminal.

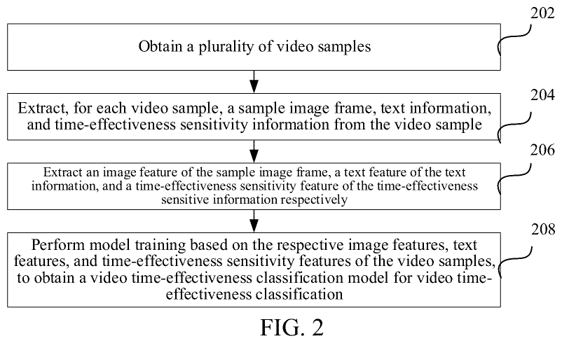

In some embodiments, as shown in FIG. 2, a video time-effectiveness classification model training method is provided. An example in which the method is applied to the server 104 is used for description in some embodiments. In some embodiments, the method may include the following operations.

Operation 202: Obtain a plurality of video samples.

The video sample is a data sample for training to obtain a video time-effectiveness classification model. The video sample not only includes a plurality of image frames, but also includes at least one of multi-type text information such as a title text, an image text, and an audio text. An image frame is a visual unit forming a video, and the video sample may be formed by synthesizing image frame sequences consecutive in time. The title text refers to literal content in a title of a video text. The image text refers to literal content in image frames included in the video sample, for example, subtitles and character information in the image frame. The audio text refers to literal content included in the audio information of the video sample, for example, a character conversation or a voice-over in the audio information.

A video type and field of the video sample are not unique. For example, the video type may include at least one of a game video, a news video, a variety video, or an episode video. The field may include, for example, at least one of various fields such as entertainment, sports, finance, and civil life. In an application, both the video sample and the to-be-classified video are short videos, and the video time-effectiveness classification model obtained by training based on the video sample is configured to perform time-effectiveness classification on the short videos. The short video is video transmission content transmitted on a short video platform, where a duration of the short video satisfies a duration condition. The duration condition may refer to that the duration is less than a set duration, or may refer to that the duration is less than or equal to a set duration. The set duration may be, for example, 3 minutes, 5 minutes, or 7 minutes.

The server may obtain the plurality of video samples from an open source database, or may obtain the plurality of video samples from a terminal. In an application, the server may obtain, from the terminal, a short video sample created by a terminal user. Further, a mode in which the server obtains the plurality of video samples may be active obtaining, or passive receiving.

Operation 204: Extract, for each video sample, a sample image frame, text information, and time-effectiveness sensitivity information from the video sample.

The sample image frame extracted from the video sample includes at least a part of image frames included in the video sample. For example, to ensure an information amount of image information, the server may extract, for each video sample, at least two sample image frames from the video sample. The text information extracted from the video sample includes at least one of title text information, image text information, and audio text information. The title text information refers to text information included in a title text of the video sample. The image text information is text information in the image frames included in the video sample. The audio text information is text information included in audio information of the video sample.

In some embodiments, the text information includes title text information, image text information, and audio text information. In some embodiments, the operation of extracting text information from the video sample includes: obtaining a preset text length of the text information, and a title text, an image text, and an audio text extracted from the video sample; concatenating the title text, the image text, and the audio text to obtain a concatenated text; and truncating or padding the concatenated text based on the preset text length, to obtain the text information of the video sample.

The preset text length may be determined by a developer according to a length of the text information included in the video sample. For example, a relatively small preset text length may be set for a short video sample. For a Chinese text, the text length in some embodiments is equal to the number of Chinese words included in the Chinese text. For an English text, the text length in some embodiments is equal to the number of English words included in the English text. The server obtains the preset text length of the text information, and the title text, the image text, and the audio text extracted from the video sample, and then concatenates the title text, the image text, and the audio text to obtain a concatenated text. If a text length of the concatenated text is greater than the preset text length, the concatenated text is truncated to obtain the corresponding text information. If the text length of the concatenated text is smaller than the preset text length, the concatenated text is padded to obtain the corresponding text information. If the text length of the concatenated text is equal to the preset text length, the concatenated text is determined as the text information of the video text. In this way, it may be ensured that text information extracted from different video samples has the same text length, so as to facilitate subsequent feature extraction, thereby improving feature extraction efficiency and accuracy.

Further, the time-effectiveness sensitivity information refers to information associated with time-effectiveness and included in the video sample. The timeliness of a video may be represented by using an effective life cycle (i.e. a time window) of the video. The effective life cycle refers to a time window in which the video may be pushed after being published. If a publishing duration of a video falls within the range of the effective life cycle, the video may be pushed to a user. Correspondingly, a video having a publishing duration exceeding the effective life cycle cannot be pushed to a user. For example, a longer effective life cycle of a video indicates that the video has a chance to be pushed and exposed within a relatively long period of time. The time-effectiveness sensitivity information may include a time-effectiveness sensitivity text in the text information. The time-effectiveness sensitivity text may be, for example, time words with different granularities such as “today”, “tomorrow”, “next Monday”, and “11:30”, or may be time related words such as “latest”, “first half”, and “pre-market”.

Furthermore, in information-intensive videos such as emergency news and episode introduction, other non-information-intensive videos (for example, shared videos of daily life and television episodes) may use a relatively high image frame switching frequency, a relatively high speed, or relatively rapid background music. Moreover, the information-intensive video may have a relatively short effective life cycle relative to the non-information-intensive video. The server may further extract the time-effectiveness sensitivity information of the video sample from the image information and audio information of the video sample. The image information of the video sample includes image information included in the image frames included in the video sample, an image frame switching frequency, and the like. The audio information of the video sample may include information such as audio content, an audio frequency, and volume. For example, the server may use the image frame switching frequency and audio frequency of the video sample as the time-effectiveness sensitivity information.

The server may extract, for each video sample, a sample image frame from image frames included in the video sample, and determine title information, image information, and audio information included in the video sample. Then, the server extracts text information and time-effectiveness sensitivity information of the video sample based on at least one of the title information, the image information, and the audio information of the video sample. Further, the server may extract the text information and the time-effectiveness sensitivity information of the video sample from the image information and the audio information of the video sample based on image audio processing technologies such as automatic speech recognition (ASR) and optical character recognition (OCR).

A mode in which the server extracts the sample image frame is not unique. For example, the server may determine the sample image frame from the image frames according to an image frame interval and an arrangement order of the image frames in the video sample. The image frame interval may be an interval sequence including a plurality of intervals. For example, the image frame interval may be represented as (1, 2, 2, . . . ). An interval between a first sample image frame and a second sample image frame is 1, an interval between the second sample image frame and a third sample image frame is 2, an interval between the third sample image frame and a fourth sample image frame is 2, and so on. The image frame interval may be, for example, a fixed interval, and can be determined by obtaining a quotient of a frame number of image frames included in the video sample and a set frame number of the sample image frames. An example in which the video sample includes 100 frames of image is used. If the set frame number of the sample image frame is 10, after the quotient is obtained, it may be determined that the image frame interval is 9. For example: image frame interval=Floor (total frame number of video sample/set frame number)−1, where Floor is a round-down function. For another example, the server may extract frames of the video sample by using a fast forward Mpeg (FFMPEG, an open-source computer program that may be configured for recording and converting digital audios and videos, and converting the digital audios and videos into a stream) tool, to obtain a sample image frame sequence corresponding to the video sample. The sample image frame sequence includes a plurality of sample image frames.

Operation 206: Extract an image feature of the sample image frame, a text feature of the text information, and a time-effectiveness sensitivity feature of the time-effectiveness sensitivity information respectively.

The image feature is feature information for representing characteristics of the sample image frame. A data form of the image feature may be a vector or a matrix, and characteristics of the sample image frame represented by the image feature may include a color, a texture, a shape, a spatial relationship, and the like. For example, the image feature may include a color feature, a texture feature, a shape feature, a spatial relationship feature, and the like. For the sample image frame, an original image is a low-level and pixel-level expression mode, and includes a large amount of redundant information. After obtaining the sample image frame, the server may perform feature extraction on the sample image frame to obtain the image feature of the image sample. Further, an algorithm used by the server to perform feature extraction on the sample image frame to obtain the image feature of the sample image frame is not unique. For example, the server may perform processing such as feature extraction and normalization on the sample image frame based on a feature extraction network, to obtain the image feature of the sample image frame. The feature extraction process may include convolution processing, pooling processing, and the like. The number of convolutions in the convolution processing may be one, two, or more. For another example, the server may perform feature extraction on the sample image frame by using a public and trained visual encoder (for example, CLIP-VIT-B/16), to obtain the image feature of the sample image frame.

The text feature is feature information for representing characteristics of the text information. Similar to the image feature, a data form of the text feature may be a vector or a matrix, and the text feature may include a semantic feature, a structure feature, a style feature, a typesetting feature, and the like. The text feature may be extracted by using a pre-trained neural network model. The neural network model may be a bags-of-words model. The model may use all words that have occurred in training data into a dictionary, and determine the text feature of the text information by counting a number of times that each word occurs in the text information. The neural network model may further be a bidirectional encoder representations from transformers (BERT) model or a model derived from the BERT model. The model includes a stack of a plurality of layers of bidirectional encoders (Transformer). A self-attention mechanism of the bidirectional encoder may concatenate information about all segmented words in the text information, to obtain the text feature of the text information. A term frequency-inverse document frequency (TF-IDF) algorithm collects statistics on the text feature of the text information.

The time-effectiveness sensitivity feature is feature information for representing characteristics of the time-effectiveness sensitivity information. A data form of the time-effectiveness sensitivity feature may be a vector or a matrix, and the time-effectiveness sensitivity feature may include a semantic feature, a frequency feature, and the like. As described above, the time-effectiveness sensitivity information may include a time-effectiveness sensitivity text in the text information, and time-effectiveness sensitivity information extracted from the image information and the audio information of the video sample. The server may determine, through linear transformation and encoding, information features respectively corresponding to time-effectiveness sensitivity information extracted from different information, and then perform feature fusion on the information features to obtain the time-effectiveness sensitivity feature of the video sample. Feature fusion is a process of generating new features from different extracted features in a mode, to obtain more effective features. A mode of feature fusion may include, for example, at least one of modes such as concatenation or feature operation.

Operation 208: Perform model training based on the respective image features, text features, and time-effectiveness sensitivity features of the video samples, to obtain a video time-effectiveness classification model for video time-effectiveness classification.

The video time-effectiveness classification model is a classification model having a video time-effectiveness classification capability. A type of the video time-effectiveness classification model is not unique, and may be, for example, a convolutional neural network (CNN), a recurrent neural network (RNN), or a transformer model.

The server may perform model training based on the respective image features, text features, and time-effectiveness sensitivity features of the video samples, to obtain a video time-effectiveness classification model for video time-effectiveness classification. In some embodiments, the server may fuse, for each video sample, an image feature, a text feature, and a time-effectiveness sensitivity feature of the video sample to obtain a multi-modal time-effectiveness feature of the video sample, and perform model training based on the respective multi-modal time-effectiveness features of the video samples, to obtain a video time-effectiveness classification model for video time-effectiveness classification. In some embodiments, the server may pre-train an initial model based on respective image features, text features, and time-effectiveness sensitivity features of video samples, to obtain a pre-trained model, and then perform, based on the pre-trained model, model training on the pre-trained model based on the respective image features, text features, and time-effectiveness sensitivity features of the video samples, to improve model training efficiency.

The foregoing video time-effectiveness classification model training method includes: obtaining a plurality of video samples; extracting, for each video sample, a sample image frame, text information, and time-effectiveness sensitivity information from the video sample; extracting an image feature of the sample image frame, a text feature of the text information, and a time-effectiveness sensitivity feature of the time-effectiveness sensitivity information respectively; and performing model training based on the respective image features, text features, and time-effectiveness sensitivity features of the video samples, to obtain a video time-effectiveness classification model for video time-effectiveness classification. This is equivalent to performing video time-effectiveness classification based on features of multiple dimensions determined based on multi-modal information such as the image information, the text information, and the time-effectiveness sensitivity information, so that a classification result no longer relies on information in a single modality. Information types used in a video time-effectiveness classification process can be enriched, an information amount of available information can be ensured, and accuracy of a time-effectiveness classification result can further be improved.

In some embodiments, the operation of obtaining a sample image frame included in the video sample includes: determining an image similarity between image frames included in the video sample; and determining a plurality of sample image frames from the image frames based on the image similarities.

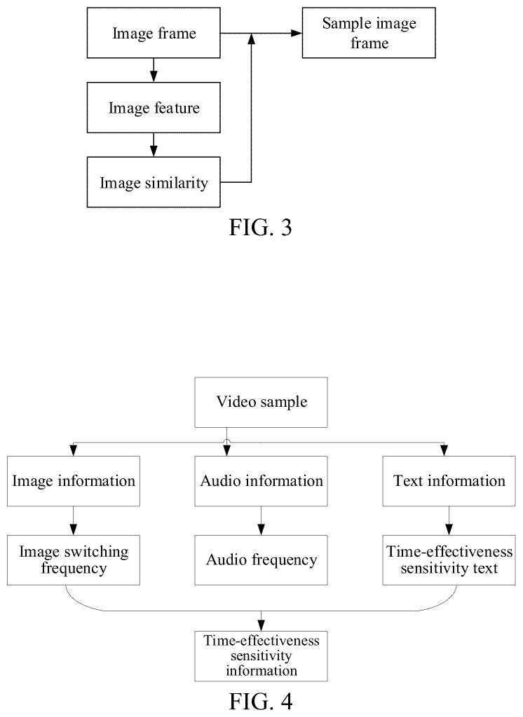

The image similarity between any two sample image frames satisfies a dissimilarity condition. The dissimilarity condition may be that the image similarity is less than a similarity threshold, or may be that the image similarity is less than or equal to the similarity threshold. As shown in FIG. 3, the server may perform feature extraction on image frames included in the video sample, determine respective image features of each image frame, and determine an image similarity between the image frames by performing cosine similarity or Euclidean distance calculation on the image features. Then, the server determines, based on the image similarities, a plurality of sample image frames having the image similarities satisfying a dissimilarity condition from the image frames.

For example, the server may use a key frame of a video sample as a first determined sample image frame, then sequentially calculate image similarities between image frames and the sample image frame along a set direction according to an order of the image frames in the video sample, and filter the image frames that do not satisfy a dissimilarity condition, until a second sample image frame that satisfies the dissimilarity condition is determined. The key frame may be, for example, a first frame, a last frame, or a frame including a largest number of image elements. The set direction may be, for example, a forward direction or a backward direction. Next, the server determines, in the remaining image frames, a third sample image frame that satisfies the dissimilarity condition with the sample image frames. The rest can be deduced by analogy, until there is no image frame that satisfies the dissimilarity condition with the sample image frames. If no image frame that satisfies the dissimilarity condition with the sample image frames exists in the remaining image frames, extraction of the sample image frames is completed.

In some embodiments, based on image similarities between image frames, a sample image frame having the image similarity satisfying a dissimilarity condition is determined from the image frames, so that the number of sample image frames can be reduced while ensuring an information amount of image information included in the sample image frames, thereby improving data processing efficiency in a model training process.

In some embodiments, the operation of extracting time-effectiveness sensitivity information from the video sample includes: extracting image information, audio information, and text information from the video sample; and determining the time-effectiveness sensitivity information in the video sample based on at least one of the image information, the audio information, or the text information.

For implementation details about the image information, the audio information, and the text information, refer to the foregoing. The server may extract image information, audio information, and text information from the video sample, and then determine the time-effectiveness sensitivity information in the video sample based on at least one of the image information, the audio information, or the text information obtained by extraction. For example, as shown in FIG. 4, the server may extract the time-effectiveness sensitivity text included in the text information, determine an image frame switching frequency based on the image information, and determine an audio frequency based on the audio information, thereby ensuring the time-effectiveness sensitivity information including the time-effectiveness sensitivity text, the image frame switching frequency, and the audio frequency.

In some embodiments, time-effectiveness sensitivity information in a video sample is determined based on at least one of image information, audio information, or text information. This is equivalent to that the time-effectiveness sensitivity information in the video sample may be extracted from multiple dimensions, so that an information amount of the time-effectiveness sensitivity information can be ensured, thereby further improving accuracy of a video time-effectiveness classification result.

In an application, the operation of determining the time-effectiveness sensitivity information in the video sample based on at least one of the image information, the audio information, or the text information includes: semantically splitting the text information to obtain a plurality of subtexts included in the text information; determining a time-effectiveness text, in the subtexts, matching a time-effectiveness sensitivity text; and determining the time-effectiveness text as the time-effectiveness sensitivity information in the video sample.

That the time-effectiveness text matches the time-effectiveness sensitivity text may mean that the time-effectiveness text is the same as the time-effectiveness sensitivity text, the time-effectiveness text includes the time-effectiveness sensitivity text, or the time-effectiveness text is semantically similar to the time-effectiveness sensitivity text. There may be one or more time-effectiveness texts included in one subtext. The server may semantically split the text information by using a natural language processing technology, to obtain a plurality of subtexts included in the text information, then match the subtexts with time-effectiveness sensitivity texts in a time-effectiveness sensitivity text library respectively, determine a time-effectiveness text matching any time-effectiveness sensitivity text in the subtexts, and determine the time-effectiveness text as the time-effectiveness sensitivity information in the video sample. Further, the time-effectiveness sensitivity text library refers to a database including a plurality of time-effectiveness sensitivity texts. The time-effectiveness sensitivity text may be, for example, time words with different granularities such as “today”, “tomorrow”, “next Monday”, and “11:30”, or may be time related words such as “latest”, “first half”, and “pre-market”. The time-effectiveness sensitivity text library may be updated periodically. The server may prompt, when accuracy of the video time-effectiveness classification model does not satisfy an accuracy condition, a developer to update the time-effectiveness sensitivity text library and perform incremental data training on the video time-effectiveness classification model.

In some embodiments, the time-effectiveness sensitivity information in the video sample is determined according to matching between the text information and the time-effectiveness sensitivity text, so as to ensure an association between the time-effectiveness sensitivity information and time-effectiveness, thereby improving working efficiency and accuracy of a subsequent model training and application process.

In an application, the image information includes an image frame switching frequency, and the audio information includes an audio frequency. In this situation, the operation of determining the time-effectiveness sensitivity information in the video sample based on at least one of the image information, the audio information, or the text information includes: determining the image frame switching frequency and the audio frequency of the video sample as the time-effectiveness sensitivity information in the video sample.

The image information of the video sample may include respective image frame information of the image frames included in the video sample, an image frame switching frequency between the image frames, and the like. The audio information of the video sample may include information such as audio content, an audio frequency, and volume. The image frame switching frequency refers to a switching frequency of the image frames in the video sample, i.e. the number of image frames projected or displayed per second. The audio frequency refers to a statistical frequency of a segment of audio. The statistical frequency may be, for example, an average frequency or a frequency median.

In information-intensive videos such as emergency news and episode introduction, other non-information-intensive videos (for example, shared videos of daily life and television episodes) may use a relatively high image frame switching frequency, a relatively high speed, or relatively rapid background music. Moreover, the information-intensive video may have a relatively short effective life cycle relative to the non-information-intensive video. The server may determine an image frame switching frequency and an audio frequency of the video sample from the image information and the audio information of the video sample, and determine the image frame switching frequency and the audio frequency as the time-effectiveness sensitivity information of the video sample.

In some embodiments, an image frame switching frequency and an audio frequency are determined as time-effectiveness sensitivity information of a video sample, which can enrich sources of the time-effectiveness sensitivity information, and ensure that the extracted time-effectiveness sensitivity information can accurately represent time-effectiveness of the video sample, thereby improving accuracy of a video time-effectiveness classification model obtained by training based on the time-effectiveness sensitivity information.

In some embodiments, the text information includes title text information, image text information, and audio text information. In some embodiments, the operation of extracting text information from the video sample includes: obtaining respective set text lengths of the title text information, the image text information, and the audio text information, and a title text, an image text, and an audio text extracted from the video sample; and truncating or padding the title text, the image text, and the audio text respectively based on the set text lengths, to obtain the title text information, the image text information, and the audio text information of the video sample. The operation of extracting a text feature of the text information includes: performing feature extraction and fusion processing on the title text information, the image text information, and the audio text information to obtain the text feature of the text information.

The title text refers to literal content in a title of a video text. The image text refers to literal content in the image frames included in the video sample. The audio text refers to literal content included in the audio information of the video sample. The server may extract the title text from the video sample, then extract, based on the OCR technology, the literal content in the image frames included in the video sample to obtain the image text of the video sample, and extract, based on the ASR technology, the literal content included in the audio information of the video sample to obtain the audio text of the video sample. Moreover, the server further obtains respective set text lengths of the title text information, the image text information, and the audio text information. The set text lengths may be determined by a developer according to a length of each type of text information included in the video samples. For example, the set text length of the title text information is relatively small, and the set text length of the audio text information is relatively large. Then, the server truncates or pads the title text, the image text, and the audio text respectively based on the set text lengths, to obtain the title text information, the image text information, and the audio text information of the video sample. The title text is used as an example. For a video sample, if a text length of a title text of the video sample is greater than a set text length of title text information, the title text is truncated. Otherwise, a padding word is added for padding, so as to ensure that the length of the title text information of the video samples obtained by truncation or padding is the set text length.

Further, after obtaining text information including title text information, image text information, and audio text information, the server may perform feature extraction and fusion processing on the title text information, the image text information, and the audio text information to obtain the text feature of the text information.

In some embodiments, a title text, an image text, and an audio text are truncated or padded respectively based on respective set text lengths of title text information, image text information, and audio text information, to obtain the title text information, the image text information, and the audio text information of video samples. On the premise that text information of the video samples has the same text length, it can be ensured that the text information includes multi-type text information such as the title text information, the image text information, and the audio text information, thereby improving an information amount included in the text information, further improving accuracy of a video time-effectiveness classification model obtained based on the text information, and improving accuracy of a video time-effectiveness classification result.

A mode of obtaining the text feature of the text information is not unique.

In some embodiments, the operation of performing feature extraction and fusion processing on the title text information, the image text information, and the audio text information to obtain the text feature of the text information includes: extracting a title text feature of the title text information, an image text feature of the image text information, and an audio text feature of the audio text information respectively; and fusing the title text feature, the image text feature, and the audio text feature to obtain the text feature of the text information.

The image text feature is feature information for representing characteristics of the image text information. The title text feature is feature information for representing characteristics of the title text information. The audio text feature is feature information for representing characteristics of the audio text information. Forms of the title text feature, the image text feature, and the audio text feature may all be vectors or matrices. Content of the title text feature, the image text feature, and the audio text feature may include a semantic feature, a structure feature, and the like. In an application, the data forms and content of the title text feature, the image text feature, and the audio text feature are the same, so as to improve feature fusion convenience.

The server may perform feature extraction on the title text information, the image text information, and the audio text information of the video sample, respectively, to obtain a title text feature, an image text feature, and an audio text feature, and then fuse the title text feature, the image text feature, and the audio text feature to obtain the text feature of the text information. A mode of fusing the title text feature, the image text feature, and the audio text feature may include a feature operation, feature concatenation, and the like.

In some embodiments, a text feature of text information is obtained by first performing feature extraction and then fusion, to ensure that the text feature can fully characterize the text information, thereby improving accuracy of a video time-effectiveness classification model obtained by training based on the text feature.

In some embodiments, the operation of performing feature extraction and fusion processing on the title text information, the image text information, and the audio text information to obtain the text feature of the text information includes: concatenating the title text information, the image text information, and the audio text information to obtain concatenated text information of the video sample; and performing feature extraction on the concatenated text information to obtain the text feature of the text information.

The server may obtain a text information concatenating order, and concatenate the title text information, the image text information, and the audio text information according to the text information concatenating order, to obtain concatenated text information of the video sample. The text information concatenating order may be random, or may be a fixed order set by a developer. Then, the server performs feature extraction on the concatenated text information to obtain the text feature of the text information. For example, the concatenated text information may be encoded by using a pre-trained text encoder (for example, BERT or Roberta), to be converted into a feature sequence. An example in which the text length of the concatenated text information is mₜ is used. A feature extraction process is a process of converting concatenated text information tᵢ={tᵢ¹, tᵢ², . . . , tᵢ^{m}^{ₜ}} into a text feature fₜ_{ᵢ}={fₜ_{ᵢ}^{CLS}, fₜ_{ᵢ}¹, fₜ_{ᵢ}², . . . , fₜ_{ᵢ}^{m}^{ₜ}}, where fₜ_{ᵢ}^{j} is a 768-dimensional vector for characterizing a semantic feature obtained by converting a j^{th} word tᵢ^{j} in tᵢ via a text encoder, and fₜ_{ᵢ}^{CLS} is a CLS flag for characterizing semantics of the entire concatenated text information.

In some embodiments, a text feature of text information is obtained by first performing fusion and then performing feature extraction. This is equivalent to that the text feature of the text information may be obtained only once by performing feature extraction, which is beneficial to improving data processing efficiency.

In some embodiments, operation 208 includes: performing model training on an initial model based on the respective image features, text features, and time-effectiveness sensitivity features of the video samples, to obtain a multi-modal pre-training model; fusing, for each video sample, the image feature, the text feature, and the time-effectiveness sensitivity feature of the video sample to obtain a multi-modal time-effectiveness feature of the video sample; and fine-tuning the multi-modal pre-training model based on the respective multi-modal time-effectiveness features of the video samples, to obtain the video time-effectiveness classification model for video time-effectiveness classification.

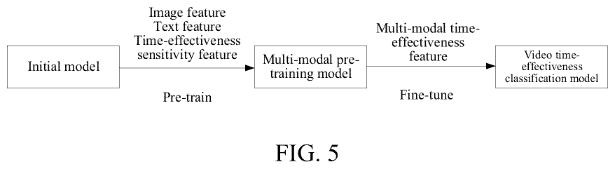

A source or form of each type of information may be in a modality. For example, forms such as text, image, and speech correspond to a modality separately. As shown in FIG. 5, the server may perform model training on an initial model based on the respective image features, text features, and time-effectiveness sensitivity features of the video samples, to obtain a multi-modal pre-training model. The multi-modal pre-training model obtained in the pre-training stage has some generalization, but cannot be directly applied to a video time-effectiveness classification function. After obtaining the multi-modal pre-training model, the server further may fine-tune the model, to obtain the video time-effectiveness classification model. The server fuses, for each video sample, an image feature, a text feature, and a time-effectiveness sensitivity feature of the video sample to obtain a multi-modal time-effectiveness feature of the video sample, and fine-tune, based on a multi-modal pre-training model, the multi-modal pre-training model based on the respective multi-modal time-effectiveness features of the video samples, to obtain a video time-effectiveness classification model for video time-effectiveness classification. An algorithm for feature fusion may include at least one of algorithms such as concatenation and feature operation. Further, a model structure of the video time-effectiveness classification model may be the same as or different from the multi-modal pre-training model. For example, the video time-effectiveness classification model may include the model structure of the multi-modal pre-training model, to ensure that model parameters of the multi-modal pre-training model may be directly reused in a fine-tuning stage.

In an application, the server may fine-tune the multi-modal pre-training model based on the respective multi-modal time-effectiveness features and time-effectiveness tags of the video samples, to obtain the video time-effectiveness classification model for video time-effectiveness classification. Each video sample corresponds to time-effectiveness tags of at least two categories. A category of a time-effectiveness tag of a video sample for model training is the same as a category of a predicted time-effectiveness tag of the video time-effectiveness classification model obtained by training. For example, according to a time-effectiveness prediction application scene, a developer may perform model fine-tuning by using a video sample carrying a time-effectiveness tag matching the application scene, to obtain a video time-effectiveness classification model matching the application scene. For example, in a ternary classification scene, the model only may be fine-tuned by using a plurality of video samples respectively carrying three categories of different time-effectiveness tags.

In some embodiments, a learning paradigm of pretrain-then-finetune is used, to ensure that a more generalized, more accurate, and more robust video time-effectiveness classification model is obtained.

In a pre-training stage, the server may perform model training on the initial model based on a single pre-training task, or may perform model training based on a plurality of different pre-training tasks, to obtain the multi-modal pre-training model. For example, in the pre-training stage, the server may obtain a multi-modal time-effectiveness feature of each video sample by fusing the image feature, the text feature, and the time-effectiveness sensitivity feature, and perform pre-training based on the multi-modal time-effectiveness feature, to obtain the multi-modal pre-training model.

In some embodiments, the operation of performing model training on an initial model based on the respective image features, text features, and time-effectiveness sensitivity features of the video samples, to obtain a multi-modal pre-training model includes: determining at least two pre-training tasks, performing model training on the initial model based on each pre-training task, to determine respective task losses of the pre-training tasks; and obtaining the multi-modal pre-training model corresponding to the initial model in a case that a pre-training loss determined according to the task losses satisfies a convergence condition.

At least one of the image feature, the text feature, or the time-effectiveness sensitivity feature is used in a model training process of each pre-training task. The at least two pre-training tasks may include a mask self-encoding task for an image frame or an image feature, a mask self-encoding task for text information or a text feature, a binary classification task based on a multi-modal time-effectiveness feature, and the like. The server determines at least two pre-training tasks, and then perform model training on the initial model based on each pre-training task, to determine respective task losses of the pre-training tasks. Next, the server statistically calculates the task losses, to determine a pre-training loss of the initial model in the pre-training process, and obtains a multi-modal pre-training model corresponding to the initial model when the pre-training loss satisfies a convergence condition. An algorithm of the statistics calculation may include, for example, at least one of addition, subtraction, multiplication, and the like. A loss function corresponding to each task loss may include, for example, a cross-entropy loss function and an exponential loss function.

In some embodiments, pre-training is performed by using a plurality of pre-training tasks, to ensure that a multi-modal pre-training model with sufficient generalization is obtained, thereby facilitating improving working efficiency of a subsequent model fine-tuning process, and improving accuracy of a video time-effectiveness classification model determined based on the multi-modal pre-training model.

In some embodiments, the pre-training task includes an image mask task for the image feature, a text mask task for the text information, and a binary classification task. In some embodiments, the operation of performing model training on the initial model based on each pre-training task, to determine respective task losses of the pre-training tasks includes: performing image mask task training on the initial model by performing mask self-encoding processing on a part of the image feature, and determining an image mask task loss of the initial model; performing text mask task training on the initial model by performing mask self-encoding processing on a part of the text information corresponding to the text feature, and determining a text mask task loss of the initial model; and performing binary classification task training on the initial model based on the multi-modal time-effectiveness feature of the video sample obtained by fusing the image feature, the text feature, and the time-effectiveness feature and a binary classification tag of the video sample, and determining a binary classification task loss of the initial model.

The mask self-encoding means that after a mask operation is performed on an original object that is inputted, an encoder receives an unmasked part, introduces a mask mark after the encoder, and decodes all encoded mask marks and unmasked parts by using a decoder, to reconstruct the original object. The server may perform image mask task training on the initial model by performing mask self-encoding processing on a part of the image feature, and determine an image mask task loss of the initial model. The server may perform text mask task training on the initial model by performing mask self-encoding processing on a part of the text information corresponding to the text feature, and determine a text mask task loss of the initial model.

An image mask task is used as an example. For example, the server may perform random mask processing on some of image features based on the initial model, predictively restore a masked image feature by learning an unmasked image feature, calculate a degree of restoring the restored image feature to an original image feature, and determine a text mask task loss. A part of the image features may be a part of image features in a video sample including a plurality of image features, or may be a part of feature images characterized by the image feature in a video sample including only one image feature. In a case that there is one sample image frame, the video sample includes only one image feature, image segmentation may be first performed on a feature image characterized by the image feature, to obtain a plurality of image sub-blocks, then mask self-encoding processing is performed on the image sub-blocks, image mask task training is performed on the initial model, and an image mask task loss of the initial model is determined. Further, the degree of restoring the original image feature by the restored image feature may be characterized by a similarity between the restored image feature and the original image feature, or a similarity between a comprehensive image feature of the video sample jointly characterized by image features after restoration and an original comprehensive image feature.

Further, the server further fuses the image feature, the text feature, and the time-effectiveness feature to obtain a multi-modal time-effectiveness feature of the video sample. Binary classification tags of the video samples are obtained, and then binary classification task training is performed on the initial model based on the respective multi-modal time-effectiveness features and binary classification tags of the video samples, to determine a binary classification task loss of the initial model. Furthermore, the binary classification task may be, for example, a binary classification task related to a video category or a video field. In an application, the binary classification task is a binary classification task for video time-effectiveness, and the binary classification tag is a binary classification time-effectiveness tag, to improve working efficiency of a subsequent model fine-tuning process. The binary classification time-effectiveness tag may be determined by setting an effective life cycle. For example, a binary classification time-effectiveness tag having an effective life cycle greater than a set effective life cycle is 1; otherwise, is 2. The set effective life cycle may be, for example, 3 days or 7 days. The binary classification time-effectiveness tag may be obtained by manual labeling, or may be determined by collecting statistics on feedback situations of historical pushing of the video sample.

In some embodiments, based on the mask self-encoding task, pre-training is further performed based on a simple binary classification task, which can improve a generalization capability of the multi-modal pre-training model obtained by pre-training.

In an application, each video sample includes a plurality of image features. In some embodiments, the operation of performing image mask task training on the initial model by performing mask self-encoding processing on a part of the image feature, and determining an image mask task loss of the initial model includes: performing, for each video sample, mask self-encoding processing on a part of the image features of the video sample, and determining a masked original image feature in the image features, and a restored image feature corresponding to the original image feature; and determining the image mask task loss of the initial model based on a feature similarity between the original image feature and the restored image feature.

The server performs, for each video sample, mask self-encoding processing on a part of the image features of the video sample, and determines a masked original image feature in the image features, and a restored image feature corresponding to the original image feature. Considering that it is relatively difficult to directly restore an image feature of an image frame in a video sample, the server uses comparison learning to maximize a similarity between a masked original image feature and a restored image feature, and uses remaining original image features in the video sample as negative samples, to reduce a similarity between the negative samples and the restored image feature. For example, each masked image feature may be transmitted to an additional fully-connected layer F_{mfm}, and mapped to a 512-bit vector fₘ. Assuming that a total of n frames of a video in a batch are masked, features of these masked frames form F_{M}={fₘ₁, fₘ₂, . . . , fₘₙ}, and an MFM loss L_{MFM} is calculated by using the following formula, where σ is a temperature coefficient:

$${L}_{M F M} = - \frac{1}{n} {\sum }_{i}^{n} log \frac{exp ( {f}_{m i}^{T} {f}_{m i} / σ )}{{\sum }_{j = 1}^{N} exp ( {f}_{m i}^{T} {f}_{m j} / σ )}$$

In some embodiments, an image mask task loss of an initial model is determined based on a feature similarity between an original image feature and a restored image feature. The algorithm is simple, facilitating improving pre-training efficiency.

In some embodiments, the text feature includes a comprehensive semantic feature of the text information. In some embodiments, the operation of fusing, for each video sample, the image feature, the text feature, and the time-effectiveness sensitivity feature of the video sample to obtain a multi-modal time-effectiveness feature of the video sample includes: determining, for each video sample, the comprehensive semantic feature of the text information in the video sample from the text feature of the video sample; and fusing, based on the comprehensive semantic feature, the image feature, the time-effectiveness sensitivity feature, and other features other than the comprehensive semantic feature in the text feature of the video sample, to obtain the multi-modal time-effectiveness feature of the video sample.

The comprehensive semantic feature of the video sample is a semantic aggregation representation of text information included in the video sample. In some embodiments, the comprehensive semantic feature of the text information in the video sample may be a semantic feature obtained by performing feature extraction on the concatenated text information of the video sample. The concatenated text information is obtained by concatenating the title text information, the image text information, and the audio text information. Other features than the comprehensive semantic feature in the text feature may include, for example, a structure feature, a style feature, and a typesetting feature.

The server determines, for each video sample, the comprehensive semantic feature of the text information in the video sample from the text feature of the video sample. For example, the comprehensive semantic feature may be a CLS feature of text information obtained by a text encoder. CLS is a word element indicating a beginning of a sequence, and is fully referred to as “classification”. In the BERT model, a first position of an input sequence is marked as <cls> for representing summary information of the entire sequence. In a training process, the BERT model learns to use the representation of the <cls> position to perform various classification tasks, such as text classification and sentiment analysis. In an encoded representation, a vector of the <cls> position may be used as an aggregation representation of the entire sequence. Then, the server fuses, based on the comprehensive semantic feature, the image feature, the time-effectiveness sensitivity feature, and other features other than the comprehensive semantic feature in the text feature of the video sample, to obtain the multi-modal time-effectiveness feature of the video sample. For example, the server may concatenate the text feature, the image feature, and the time-effectiveness sensitivity feature of the video sample to obtain a concatenated feature, and transmit the concatenated feature to a fusion encoder based on a self-attention mechanism, so that various features are fully interactively fused to obtain the multi-modal time-effectiveness feature of the video sample. Further, before concatenation, a fully-connected layer may further be used to perform dimension-ascending processing on a feature having a relatively small dimension, to ensure that the concatenated features have the same dimension, thereby improving subsequent fusion efficiency.

In some embodiments, feature fusion is performed based on a comprehensive semantic feature of text information, to obtain a multi-modal time-effectiveness feature, so as to ensure semantic matching between the multi-modal time-effectiveness feature and the text information, thereby ensuring a degree of matching between the multi-modal time-effectiveness feature and a video sample, and improving accuracy of a video time-effectiveness classification model determined by subsequently performing model training based on the multi-modal time-effectiveness feature.

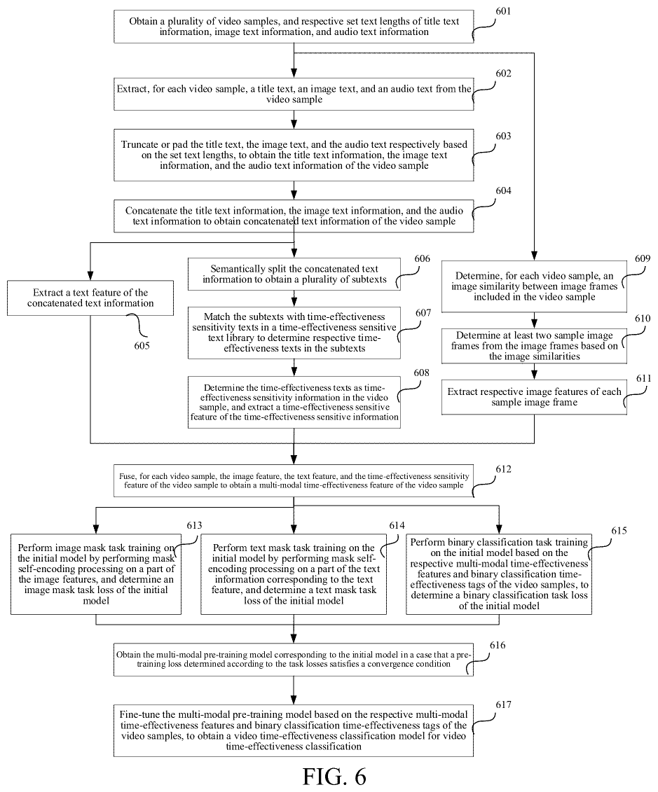

In some embodiments, as shown in FIG. 6, a video time-effectiveness classification model training method includes:

Operation 601: Obtain a plurality of video samples, and respective set text lengths of title text information, image text information, and audio text information.

Operation 602: Extract, for each video sample, a title text, an image text, and an audio text from the video sample.

Operation 603: Truncate or pad the title text, the image text, and the audio text respectively based on the set text lengths, to obtain the title text information, the image text information, and the audio text information of the video sample.

Operation 604: Concatenate the title text information, the image text information, and the audio text information to obtain concatenated text information of the video sample.

Operation 605: Extract a text feature of the concatenated text information.

Operation 606: Semantically split the concatenated text information to obtain a plurality of subtexts.

Operation 607: Match the subtexts with time-effectiveness sensitivity texts in a time-effectiveness sensitivity text library to determine respective time-effectiveness texts in the subtexts.

Operation 608: Determine the time-effectiveness texts as time-effectiveness sensitivity information in the video sample, and extract a time-effectiveness sensitivity feature of the time-effectiveness sensitivity information.

Operation 609: Determine, for each video sample, an image similarity between image frames included in the video sample.

Operation 610: Determine at least two sample image frames from the image frames based on the image similarities.

The image similarity between any two sample image frames satisfies a dissimilarity condition.

Operation 611: Extract respective image features of each sample image frame.

Operation 612: Fuse, for each video sample, the image feature, the text feature, and the time-effectiveness sensitivity feature of the video sample to obtain a multi-modal time-effectiveness feature of the video sample.

Operation 613: Perform image mask task training on the initial model by performing mask self-encoding processing on a part of the image features, and determine an image mask task loss of the initial model.

Operation 614: Perform text mask task training on the initial model by performing mask self-encoding processing on a part of the text information corresponding to the text feature, and determine a text mask task loss of the initial model.

Operation 615: Perform binary classification task training on the initial model based on the respective multi-modal time-effectiveness features and binary classification time-effectiveness tags of the video samples, to determine a binary classification task loss of the initial model.

Operation 616: Obtain the multi-modal pre-training model corresponding to the initial model in a case that a pre-training loss determined according to the task losses satisfies a convergence condition.

Operation 617: Fine-tune the multi-modal pre-training model based on the respective multi-modal time-effectiveness features and binary classification time-effectiveness tags of the video samples, to obtain a video time-effectiveness classification model for video time-effectiveness classification.

As described above, after obtaining the video time-effectiveness classification model, the server may perform video time-effectiveness classification on a to-be-classified video based on the video time-effectiveness classification model. An application process of the video time-effectiveness classification model in some embodiments is described below.

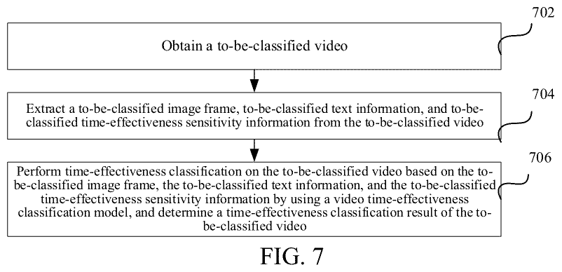

In some embodiments, as shown in FIG. 7, a video time-effectiveness classification method. An example in which the method is applied to the server in FIG. 1 is used for description. In some embodiments, the method includes the following operations.

Operation 702: Obtain a to-be-classified video.

Operation 704: Extract a to-be-classified image frame, to-be-classified text information, and to-be-classified time-effectiveness sensitivity information from the to-be-classified video.

Operation 706: Perform time-effectiveness classification on the to-be-classified video based on the to-be-classified image frame, the to-be-classified text information, and the to-be-classified time-effectiveness sensitivity information by using a video time-effectiveness classification model, and determine a time-effectiveness classification result of the to-be-classified video.

The video time-effectiveness classification model is obtained by training based on the foregoing method. The to-be-classified video is a video on which time-effectiveness classification may be performed. Similar to the video sample, the to-be-classified video includes a plurality of image frames and at least one of a plurality of types of text information such as a title text, an image text, and an audio text. In addition, a video type of the to-be-classified video may be a game video, a news video, a variety video, an episode video, or the like. The field to which the to-be-classified video belongs may be entertainment, sports, finance, civil life, or the like. For a mode of extracting the to-be-classified image frame, the to-be-classified text information, and the to-be-classified time-effectiveness sensitivity information from the to-be-classified video, refer to the foregoing mode of extracting the sample image frame, the text information, and the time-effectiveness sensitivity information from the video sample.

The server may obtain a to-be-classified video, extract a to-be-classified image frame, to-be-classified text information, and to-be-classified time-effectiveness sensitivity information from the to-be-classified video, perform time-effectiveness classification on the to-be-classified video by using the to-be-classified image frame, the to-be-classified text information, and the to-be-classified time-effectiveness sensitivity information as inputs of a video time-effectiveness classification model, and determine an output of the video time-effectiveness classification model as a time-effectiveness classification result of the to-be-classified video. The time-effectiveness classification result may be represented by using an effective life cycle, or may be represented by using a time-effectiveness tag that may characterize the effective life cycle. After obtaining the time-effectiveness classification result of the to-be-classified video, the server may perform video pushing on the to-be-classified video based on the time-effectiveness classification result, to improve a pushing effect.

The foregoing video time-effectiveness classification method includes: obtaining a to-be-classified video; extracting a to-be-classified image frame, to-be-classified text information, and to-be-classified time-effectiveness sensitivity information from the to-be-classified video; and performing time-effectiveness classification on the to-be-classified video based on the to-be-classified image frame, the to-be-classified text information, and the to-be-classified time-effectiveness sensitivity information by using a video time-effectiveness classification model, and determining a time-effectiveness classification result of the to-be-classified video. This is equivalent to performing video time-effectiveness classification based on features of multiple dimensions determined based on multi-modal information such as the image information, the text information, and the time-effectiveness sensitivity information, so that a classification result no longer relies on information in a single modality. Information types used in a video time-effectiveness classification process can be enriched, an information amount of available information can be ensured, and accuracy of a time-effectiveness classification result can further be improved.

The following describes a video time-effectiveness classification model training method and a video time-effectiveness classification method in detail by using a short video classification scene as an example. In recent years, with the rapid popularization of short video platforms, short videos gradually become one of important media for people to learn about current hotspots, share personal life, and pass time for leisure. A short video platform uploads a large amount of video content every day, which relates to various fields such as entertainment, sports, finance, and civil life. Videos in different fields have different time-effectiveness. For example, a short video about breaking news may have a relatively short time-effectiveness (for example, 1 day) due to rapid event development, while a short video shared by real photos in daily life has a relatively long time-effectiveness (for example, 3 months). Only when the short video platform pushes content to a user within a time period, the user does not generate a feeling of information lag, distraction, and no value, and is willing to spend time browsing more videos. Therefore, time-effectiveness identification of a short video plays a very important role for the platform to improve stay duration of the user and user experience.

The time-effectiveness identification of the short video may be characterized by an effective life cycle (time window) that may be recommended after the video is published. The effective life cycle may be a time window of different lengths such as 6 hours, 1 day, 3 days, 7 days, 1 month, 3 months, or permanent. The video is pushed to the user within the effective life cycle, to ensure a video pushing effect. For example, the video has a chance to be recommended only in the time window, and cannot be recommended to the user if the publishing duration exceeds the time window. A longer time window indicates that the video will have a chance to be recommended and exposed within a longer period of time. A short video time-effectiveness prediction task is defined as: a short video is given, and an effective life cycle of the short video is accurately predicted. In the technology, it is difficult to accurately predict time-effectiveness simply by relying on text information. Considering that a presentation form of content of a short video is not limited to expression of text information, and visual information can bring more direct content transmission to a user from the perspective, for time-effectiveness prediction of the short video, multi-modal information such as visual information, text information, and audio information is fully used to make more accurate prediction. Based on this, some embodiments provide a short video time-effectiveness model training method and a short video time-effectiveness classification method with multi-modal information fusion. The method has more robustness to impact on text information, so that a time-effectiveness classification result of a short video may be determined more precisely no matter whether the text information is sufficient.

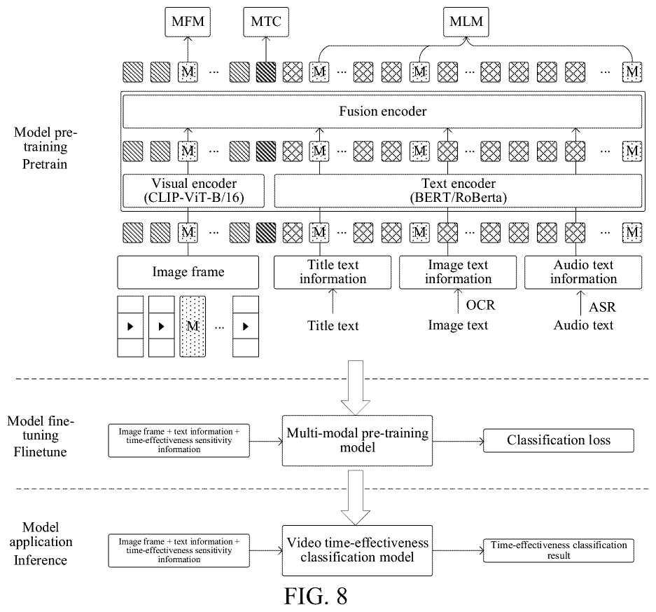

In some embodiments, as shown in FIG. 8, a model training process includes two stages: pre-train (pretrain) and fine-tune (finetune). The pre-training stage includes the following operations.

Operation (1.1): Pre-process input data.

The input data may include video information vᵢ of a video sample and a title text tᵢ^{title}. For a plurality of image frames included in the video information, the server may obtain a series of sample image frame sequences vᵢ={vᵢ¹, vᵢ², . . . , vᵢ^{m}^{ᵥ}} by frame extraction. A frame number my may be a fixed number, or may be a variable number. To enrich text information, an image audio processing technology such as ASR or OCR may be used to extract OCR (denoted as tᵢ^{ocr}) and ASR (denoted as tᵢ^{asr}) information of a video from the video information as input. Further, time-effectiveness sensitivity information may further be extracted from the text information such as tᵢ^{title}, tᵢ^{ocr}, and tᵢ^{asr} as Tᵢ^{time}. Finally, an input for a video sample i includes (vᵢ, tᵢ^{title}, tᵢ^{ocr}, tᵢ^{asr}, Tᵢ^{time}).

Operation (1.2): Extract a video feature.

The sample image frame sequence vᵢ={vᵢ¹, vᵢ², . . . , vᵢ^{m}^{ᵥ}} of each video sample may be converted into a corresponding image feature sequence by using a powerful visual feature extraction capability of a public pre-trained visual encoder (for example, CLIP-ViT-B/16), and denoted as fᵥ_{ᵢ}={fᵥ_{ᵢ}¹, fᵥ_{ᵢ}², . . . , fᵥ_{ᵢ}^{m}^{ᵥ}}, where fᵥ_{ᵢ}^{j} is a 512-dimensional vector, representing a visual feature vector obtained by converting a video frame vᵢ^{j} via the visual encoder.

Operation (1.3): Extract a text feature and a time-effectiveness sensitivity feature.

The server may concatenate different types of text information into a concatenated text tᵢ having a maximum length of mₜ according to an order of (tᵢ^{title}, tᵢ^{ocr}, tᵢ^{asr}). When a text length exceeds mₜ, truncation is performed, and when the text length is less than mₜ, [PAD] is added for padding. Then, by using a public pre-trained text encoder (for example, BERT/Roberta), each concatenated text tᵢ={tᵢ¹, tᵢ², . . . , tᵢ^{m}^{ₜ}} is inputted and converted into a corresponding word feature sequence, which is denoted as fₜ_{ᵢ}={fₜ_{ᵢ}^{CLS}, fₜ_{ᵢ}¹, fₜ_{ᵢ}², . . . , fₜ_{ᵢ}^{m}^{ₜ}}, where fₜ_{ᵢ}^{j} is a 768-dimensional vector and is a semantic feature representation obtained by converting a j^{th} word tᵢ^{j} in the concatenated text tᵢ via the text encoder, and fₜ_{ᵢ}^{CLS} is a [CLS] flag for characterizing semantics of the concatenated text. The server may extract a time-effectiveness sensitivity feature f_{T}ⁱ of the time-effectiveness sensitivity information by using the text encoder.

Operation (1.4): Fuse multi-modal information.

After a video frame feature sequence fᵥ_{ᵢ}={fᵥ_{ᵢ}¹, fᵥ_{ᵢ}², . . . , fᵥ_{ᵢ}^{m}^{ᵥ}}, a text feature sequence fₜ_{ᵢ}={fₜ_{ᵢ}^{CLS}, fₜ_{ᵢ}¹, fₜ_{ᵢ}², . . . , fₜ_{ᵢ}^{m}^{ₜ}}, and a time-effectiveness sensitivity feature f_{T}_{ᵢ} are obtained, f_{tvT_i}={fₜᵢ, fᵥᵢ, f_{T}_{ᵢ}}={fₜ_{ᵢ}^{CLS}, fₜ_{ᵢ}¹, fₜ_{ᵢ}², . . . , fₜ_{ᵢ}^{m}^{ₜ}, fᵥ_{ᵢ}¹, fᵥ_{ᵢ}², . . . , fᵥ_{ᵢ}^{m}^{ᵥ}, f_{T}_{ᵢ}} is obtained by further concatenation, and f_{tvT_i} is transmitted to a fusion encoder, so that interaction and fusion of the visual feature and the text information are sufficiently performed, and a predicted value used by calculation of each pre-training task Loss is outputted. Further, since a vector dimension of the visual feature is different from a vector dimension of the text feature, a fully-connected layer may be used before feature concatenation, to increase the dimension of the visual feature to 768, which is the same as that of the text feature.

Operation (1.5): Calculate a loss of each pre-training task.

The pre-training task used in some embodiments includes a masked language model (MLM), a mask frame model (MFM), and a multi-class tag classification (MTC), which are as follows:

MLM: The task is put forward in BERT. Some words in input text information are randomly masked, and the masked words are replaced with marks [MASK] and inputted to a model to perform forward operation, so that the model predicts and restores the masked words by learning an unmasked text. Essentially, the task may be modeled as a classification problem. A feature vector corresponding to each [MASK] outputted by the last layer of the foregoing fusion encoder is transmitted to an additional fully-connected layer Fₘᵢₘ. A probability distribution y of the word as each word in a vocabulary is predicted. An input dimension of the fully-connected layer is 768, and an output dimension is Mw (size of a vocabulary set). Finally, based on the probability \tilde{y} and a real word id distribution y, a cross entropy loss is calculated according to the following formula, where N represents the number of words that may be predicted in a batch:

$${L}_{M L M} = - \frac{1}{N} {\sum }_{i}^{N} {\sum }_{c = 1}^{{M}_{w}} {y}_{i}^{c} log$$

MFM: The task is similar to the MLM task. Image features of some image frames are randomly masked, and the masked image features are set as all-0 vectors and inputted into a fusion model to perform forward operation, so that the model predictively restores the masked image features by learning an unmasked image frame. Since the image features are difficult to be reconstructed, the image features are not directly predicted and restored. Instead, comparison learning is used to maximally mask the similarity between the image features and the original image features, and the remaining image features in a batch are considered as negative sample pairs, to reduce the similarity between the features. Each masked image feature that is outputted by the fusion encoder is transmitted to an additional fully-connected layer F_{mfm}, and mapped to a 512-bit vector fₘ. Assuming that a total of n frames of a video in a batch are masked, these masked image features form F_{M}={fₘ₁, fₘ₂, . . . , fₘₙ}, and an MFM loss L_{MFM} is calculated by using the following formula, where σ is a temperature coefficient:

$${L}_{M F M} = - \frac{1}{n} {\sum }_{i}^{n} log \frac{exp ( {f}_{m i}^{T} {f}_{m i} / σ )}{{\sum }_{j = 1}^{N} exp ( {f}_{m i}^{T} {f}_{m j} / σ )}$$

MTC: The task is a multi-tag classification task, and aims to predict which semantic tags are included in each video content, so that a model can further generate multi-modal semantic features with similar semantics. The task may be modeled into a plurality of binary classification tasks for video time-effectiveness, and a semantic label for calculating the loss is manually labeled. A [CLS] feature outputted by the last layer of the fusion encoder is used as an overall multi-modal feature of a video, and then is transmitted to another fully-connected layer F_{tag}. A probability distribution \tilde{y} of the video as each tag in a tag set is predicted. An input dimension of the fully-connected layer is 768, and an output dimension is Mₜ (size of the tag set). Finally, based on the probability y and a real tag distribution y, a cross entropy loss is calculated according to the following formula, where N represents the number of videos that are to be used in a batch:

$${L}_{M T C} = - \frac{1}{N} {\sum }_{i = 1}^{N} {\sum }_{j}^{{M}_{t}} {y}_{j} log \tilde{{y}_{j}} + ( 1 - {y}_{j} ) log ( 1 - \tilde{{y}_{j}} )$$

Operation (1.6): Perform gradient back-transmission until a model converges.

A complete loss function is calculated as follows, where λₙ, n∈{1,2,3} represents weights of different losses. Operations (1.1) to (1.5) are repeated until the model converges, so that a multi-modal pre-training model may be obtained.

$$L = {λ}_{1} {L}_{M L M} + {λ}_{2} {L}_{M F M} + {λ}_{3} {L}_{M T C}$$

Further, the fine-tuning stage includes the following operations.

Operation (2.1): Prepare and pre-process labeled data.

An objective of fine-tuning is to enable the model to have a capability of time-effectiveness classification. The model may be fine-tuned on data having a time-effectiveness category to achieve this objective. The data of the time-effectiveness category may be manually labeled and obtained according to a labeling rule. The labeling rule may cover various short video content topics. The time-effectiveness level classification may be formulated according to a product requirement, for example, 6 hours, 1 day, 3 days, 7 days, 1 month, 3 months, or permanent validity. It is assumed that there are K time-effectiveness levels, and in final labeled data, each video vᵢ corresponds to atime-effectiveness category yᵢ^{k}, k∈[1, 2, . . . . K]. After the labeled data is prepared, the data still may be pre-processed according to operation (1.1), and may be transmitted to the model for fine-tuning.

Operation (2.2): Load pre-training model parameters and extract a multi-modal feature.

In addition to different loss calculation modes, a fine-tuned model may use a model structure the same as that for pre-training, and pre-trained model parameters are loaded to perform further fine-tune training. In addition, in the same mode as operations (1.2) to (1.4), the [CLS] feature outputted by the last layer of the fusion encoder is used as a multi-modal feature of the entire video to be extracted, and the dimension is 768. Since parameters trained by using a plurality of pre-training tasks are loaded, the multi-modal feature already has general and discriminative video semantic features.

Operation (2.3): Calculate a classification loss.

The foregoing 768-dimensional multi-modal eigenvector is transmitted to a randomly initialized fully-connected layer f_{cls}. A probability [symbol] of the video vᵢ as each time-effectiveness category k is predicted. An input dimension of the fully-connected layer is 768, and an output dimension is K (number of time-effectiveness categories). Finally, based on the probability [symbol] and a real tag distribution yᵢ^{k}, a cross entropy loss is calculated as shown in the following formula, where N represents the number of videos in a batch:

$${L}_{C L S} = - \frac{1}{N} {\sum }_{i}^{N} {\sum }_{k = 1}^{K} {y}_{i}^{k} log$$

Operation (2.4): Perform, for data of each batch, loss calculation by repeating operations (2.2) to (2.3), and perform gradient back-transmission until a model converges.

So far, the model in some embodiments has a capability of predicting time-effectiveness, and since visual information and text information are comprehensively used in the model at a finetune stage, the model is more robust to negative impacts caused by different lengths of text information and excessive noise. In a model application stage, a video and corresponding text information are inputted, and a category having a highest output probability may be selected as a time-effectiveness category of the video.

Although the operations are displayed sequentially according to the instructions of the arrows in the flowcharts involved in some embodiments as described above, these operations are not necessarily performed sequentially according to the sequence instructed by the arrows. Unless otherwise specified, execution of the operations is not strictly limited, and the operations may be performed in other sequences. Moreover, at least some of the operations in flowcharts in some embodiments may include a plurality of sub-operations or a plurality of stages. The operations or stages are not necessarily performed at the same moment but may be performed at different moments. Execution of the operations or stages is not necessarily sequentially performed, but may be performed alternately with other operations or at least some operations or stages of other operations.

Some embodiments further provide a video time-effectiveness classification model training apparatus, configured to implement the foregoing video time-effectiveness classification model training method. Some embodiments for the apparatus are similar to the foregoing method. Therefore, for implementation details, reference may be made to the descriptions of the video time-effectiveness classification model training method.

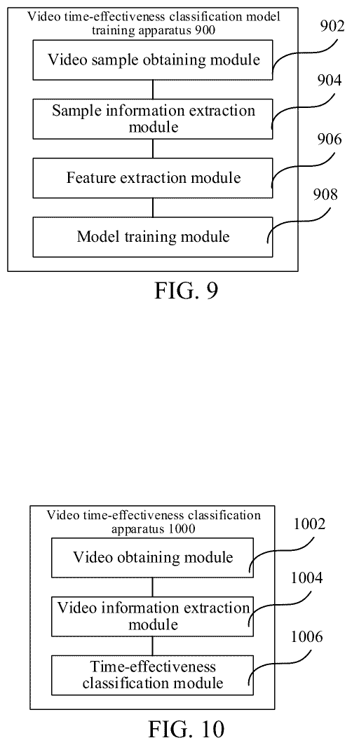

In some embodiments, as shown in FIG. 9, a video time-effectiveness classification model training apparatus 900 is provided, including a video sample obtaining module 902, a sample information extraction module 904, a feature extraction module 906, and a model training module 908.

The video sample obtaining module 902 is configured to obtain a plurality of video samples.

The sample information extraction module 904 is configured to extract, for each video sample, a sample image frame, text information, and time-effectiveness sensitivity information from the video sample.

The feature extraction module 906 is configured to extract an image feature of the sample image frame, a text feature of the text information, and a time-effectiveness sensitivity feature of the time-effectiveness sensitivity information respectively.

The model training module 908 is configured to perform model training based on the respective image features, text features, and time-effectiveness sensitivity features of the video samples, to obtain a video time-effectiveness classification model for video time-effectiveness classification.

In some embodiments, the sample information extraction module 904 includes: an information extraction unit, configured to extract image information, audio information, and text information from the video sample; and a time-effectiveness sensitivity information determining unit, configured to determine the time-effectiveness sensitivity information in the video sample based on at least one of the image information, the audio information, or the text information.

In some embodiments, the time-effectiveness sensitivity information determining unit is configured to: semantically split the text information to obtain a plurality of subtexts included in the text information; determine a time-effectiveness text, in the subtexts, matching a time-effectiveness sensitivity text; and determine the time-effectiveness text as the time-effectiveness sensitivity information in the video sample.

In some embodiments, the image information includes an image frame switching frequency, and the audio information includes an audio frequency. In some embodiments, the time-effectiveness sensitivity information determining unit is configured to: determine the image frame switching frequency and the audio frequency of the video sample as the time-effectiveness sensitivity information in the video sample.

In some embodiments, the text information includes title text information, image text information, and audio text information. In some embodiments, the sample information extraction module 904 includes: a text information obtaining unit, configured to obtain respective set text lengths of the title text information, the image text information, and the audio text information, and a title text, an image text, and an audio text extracted from the video sample; and a text processing unit, configured to truncate or pad the title text, the image text, and the audio text respectively based on the set text lengths, to obtain the title text information, the image text information, and the audio text information of the video sample. The feature extraction module 906 is configured to: perform feature extraction and fusion processing on the title text information, the image text information, and the audio text information to obtain the text feature of the text information.

In some embodiments, the feature extraction module 906 is configured to: extract a title text feature of the title text information, an image text feature of the image text information, and an audio text feature of the audio text information respectively; and fuse the title text feature, the image text feature, and the audio text feature to obtain the text feature of the text information.

In some embodiments, the feature extraction module 906 is configured to: concatenate the title text information, the image text information, and the audio text information to obtain concatenated text information of the video sample; and perform feature extraction on the concatenated text information to obtain the text feature of the text information.

In some embodiments, the model training module 908 includes: a text processing unit, configured to model training on an initial model based on the respective image features, text features, and time-effectiveness sensitivity features of the video samples, to obtain a multi-modal pre-training model; a multi-modal feature fusion unit, configured to fuse, for each video sample, the image feature, the text feature, and the time-effectiveness sensitivity feature of the video sample to obtain a multi-modal time-effectiveness feature of the video sample; and a model fine-tuning unit, configured to fine-tune the multi-modal pre-training model based on the respective multi-modal time-effectiveness features of the video samples, to obtain the video time-effectiveness classification model for video time-effectiveness classification.

In some embodiments, the pre-training unit includes: a pre-training task determining component, configured to determine at least two pre-training tasks, where at least one of the image feature, the text feature, or the time-effectiveness sensitivity feature is used in a model training process of each of the pre-training tasks; a task loss determining component, configured to perform model training on the initial model based on each pre-training task, to determine respective task losses of the pre-training tasks; and a multi-modal pre-training model obtaining component, configured to obtain the multi-modal pre-training model corresponding to the initial model in a case that a pre-training loss determined according to the task losses satisfies a convergence condition.

In some embodiments, the pre-training task includes an image mask task for the image feature, a text mask task for the text information, and a binary classification task. In some embodiments, the task loss determining component includes: an image mask task loss determining sub-component, configured to perform image mask task training on the initial model by performing mask self-encoding processing on a part of the image feature, and determine an image mask task loss of the initial model; a text mask task loss determining sub-component, configured to perform text mask task training on the initial model by performing mask self-encoding processing on a part of the text information corresponding to the text feature, and determine a text mask task loss of the initial model; and a binary classification task loss determining sub-component, configured to perform binary classification task training on the initial model based on the multi-modal time-effectiveness feature of the video sample obtained by fusing the image feature, the text feature, and the time-effectiveness feature and a binary classification tag of the video sample, and determine a binary classification task loss of the initial model.

In some embodiments, each video sample includes a plurality of image features. In some embodiments, the image mask task loss determining sub-component is configured to: perform, for each video sample, mask self-encoding processing on a part of the image features of the video sample, and determine a masked original image feature in the image features, and a restored image feature corresponding to the original image feature; and determine the image mask task loss of the initial model based on a feature similarity between the original image feature and the restored image feature.

In some embodiments, the text feature includes a comprehensive semantic feature of the text information. In some embodiments, the multi-modal feature fusion unit is configured to: determine, for each video sample, the comprehensive semantic feature of the text information in the video sample from the text feature of the video sample; and fuse, based on the comprehensive semantic feature, the image feature, the time-effectiveness sensitivity feature, and other features other than the comprehensive semantic feature in the text feature of the video sample, to obtain the multi-modal time-effectiveness feature of the video sample.

In some embodiments, the sample information extraction module 904 includes a sample image frame extraction unit, configured to: determine an image similarity between image frames included in the video sample; and determine a plurality of sample image frames from the image frames based on the image similarities, where the image similarity between any two sample image frames satisfies a dissimilarity condition.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

All or a part of the modules in the foregoing video time-effectiveness classification model training apparatus for may be implemented by using software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

Some embodiments further provide a video time-effectiveness classification apparatus, configured to implement the foregoing video time-effectiveness classification method. Some embodiments for the apparatus are similar to the method embodiments. For implementation details, reference may be made to the descriptions of the video time-effectiveness classification method.

In some embodiments, as shown in FIG. 10, a video time-effectiveness classification apparatus 1000 is provided, including a video obtaining module 1002, a video information extraction module 1004, and a time-effectiveness classification module 1006.

The video obtaining module 1002 is configured to obtain a to-be-classified video.

The video information extraction module 1004 is configured to extract a to-be-classified image frame, to-be-classified text information, and to-be-classified time-effectiveness sensitivity information from the to-be-classified video.

The time-effectiveness classification module 1006 is configured to perform time-effectiveness classification on the to-be-classified video based on the to-be-classified image frame, the to-be-classified text information, and the to-be-classified time-effectiveness sensitivity information by using a video time-effectiveness classification model, and determine a time-effectiveness classification result of the to-be-classified video. The video time-effectiveness classification model is obtained by training based on the foregoing video time-effectiveness classification model training method.

All or a part of the modules in the foregoing video time-effectiveness classification apparatus for may be implemented by using software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

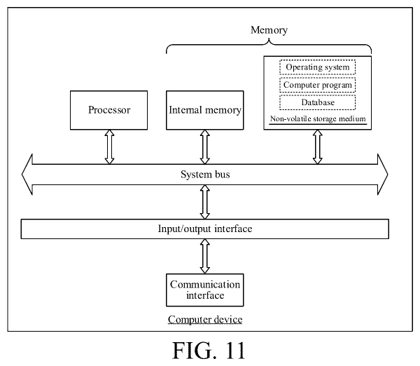

In some embodiments, a computer device is provided. The computer device may be a server, and an internal structure diagram thereof may be shown in FIG. 11. The computer device includes a processor, a memory, an input/output (I/O) interface, and a communication interface. The processor, the memory, and the I/O interface are connected via a system bus. The communication interface is connected to the system bus via the I/O interface. The processor of the computer device is configured to provide computing and control capabilities. The memory of the computer device includes a non-volatile storage medium and an internal memory. The non-volatile storage medium stores an operating system, computer programs, and databases. The inner memory provides an operating environment for the operating system and the computer programs in the non-volatile storage medium. The database of the computer device is configured to store data involved in the foregoing method. The I/O interface of the computer device is configured to exchange information between the processor and an external device. The communication interface of the computer device is configured to communicate with an external terminal through a network connection. The computer program, when executed by the processor, implements a video time-effectiveness classification model training method or a video time-effectiveness classification method.

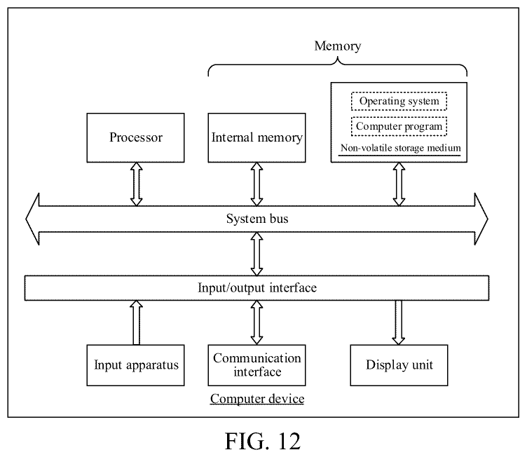

In some embodiments, a computer device is provided. The computer device may be a terminal, and an internal structure diagram thereof may be shown in FIG. 12. The computer device includes one or more processors, a memory, an I/O interface, a communication interface, a display unit, and an input apparatus. The processor, the memory, and the I/O interface are connected via a system bus. The communication interface, the display unit, and the input apparatus are connected to a system bus via the I/O interface. The processor of the computer device is configured to provide computing and control capabilities. The memory of the computer device includes a non-volatile storage medium and an internal memory. The non-volatile storage medium stores an operating system and computer-readable instructions. The inner memory provides an operating environment for the operating system and the computer programs in the non-volatile storage medium. The I/O interface of the computer device is configured to exchange information between the processor and an external device. The communication interface of the computer device is configured for wired or wireless communication with an external terminal. The wireless communication may be realized through WIFI, a mobile cellular network, near-field communication (NFC), or other technologies. The computer-readable instructions, when executed by the one or more processors, implement a video time-effectiveness classification model training method or a video time-effectiveness classification method. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

A person skilled in the art may understand that the structure shown in FIG. 11 and FIG. 12 is merely a block diagram of a partial structure related to a solution in some embodiments, and does not constitute a limitation to the computer device to which the solution in some embodiments is applied. The computer device may include more or fewer components than those shown in the figure, or some components may be combined, or a different component layout may be used.

In some embodiments, a computer device is provided. The computer device includes a memory and one or more processors. The memory has computer-readable instructions stored therein. The one or more processors, when executing the computer-readable instructions, implement the operations in some embodiments.

In some embodiments, a computer-readable storage medium is provided. The computer-readable storage medium has computer-readable instructions stored therein. The computer-readable instructions, when executed by one or more processors, implement the operations in some embodiments.

In some embodiments, a computer program product is provided, including computer-readable instructions. The computer-readable instructions, when executed by one or more processors, implement the operations in some embodiments.

User information (including, but not limited to, user equipment information, user personal information, and the like) and data (including, but not limited to, data for analysis, stored data, displayed data, and the like) involved in some embodiments are all information and data authorized by users or fully authorized by all parties, and collection, use, and processing of relevant data should comply with relevant laws, regulations, and standards of relevant countries and regions.

A person of ordinary skill in the art may understand that all or some of the procedures of the methods of some embodiments may be implemented by computer-readable instructions instructing relevant hardware. The computer-readable instructions may be stored in a non-volatile computer-readable storage medium. When the computer-readable instructions are executed, the procedures of some embodiments of the foregoing methods may be included. Any reference to a memory, a database, or another medium used in the various embodiments provided by some embodiments may include at least one of non-volatile and volatile memories. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. As an illustration rather than a limitation, the RAM is available in various forms, such as a static random access memory (SRAM) or a dynamic random access memory (DRAM). The database involved in some embodiments may include at least one of a relational database and a non-relational database. The non-relational database may include a blockchain-based distributed database, or the like, but is not limited thereto. The processor involved in some embodiments may be a central processing unit (CPU), a central processing unit, a graphics processing unit, a digital signal processor, a programmable logic device, a quantum computing-based data processing logic device, or the like, but is not limited thereto.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A training method for a video time-effectiveness classification model, performed by a computer device, the method comprising:
obtaining a plurality of video samples;
extracting, from the plurality of video samples, a plurality of sample image frames, first text information, and time-effectiveness sensitivity information;
extracting a plurality of image features from the plurality of sample image frames, a plurality of text features from the first text information, and a plurality of time-effectiveness sensitivity features of the time-effectiveness sensitivity information; and
generating a trained video time-effectiveness classification model from an untrained neural network model by training the neural network model based on the plurality of image features, the plurality of text features, and the plurality of time-effectiveness sensitivity features, wherein the trained video time-effectiveness classification model is configured to receive a video sample as input and output a predicted effective life cycle classification result.

2. The training method according to claim 1, wherein the extracting the time-effectiveness sensitivity information comprises:
extracting image information, audio information, and second text information from the plurality of video samples; and
determining the time-effectiveness sensitivity information in the video sample based on at least one of the image information, the audio information, or the second text information.

3. The training method according to claim 2, wherein the determining the time-effectiveness sensitivity information comprises:
semantically splitting the second text information to obtain a plurality of subtexts from the second text information;
determining time-effectiveness text, from among the plurality of subtexts, wherein the time-effectiveness text corresponds to time-effectiveness sensitivity text; and
determining the time-effectiveness text as the time-effectiveness sensitivity information in the video sample.

4. The training method according to claim 2, wherein the image information comprises an image frame switching frequency, and the audio information comprises an audio frequency, and
wherein the determining the time-effectiveness sensitivity information comprises determining the image frame switching frequency and the audio frequency as the time-effectiveness sensitivity information.

5. The training method according to claim 1, wherein the first text information comprises title text information, image text information, and audio text information,
wherein the extracting the first text information from the video sample comprises:
obtaining set text lengths of the title text information, the image text information, and the audio text information, and a title text, an image text, and an audio text extracted from the video sample; and
truncating or padding the title text, the image text, and the audio text based on the set text lengths, to obtain the title text information, the image text information, and the audio text information of the video sample, and
wherein the extracting the plurality of text features from the first text information comprises performing feature extraction and fusion processing on the title text information, the image text information, and the audio text information.

6. The training method according to claim 5, wherein the performing the feature extraction and the fusion processing comprises:
extracting a title text feature of the title text information, an image text feature of the image text information, and an audio text feature of the audio text information; and
fusing the title text feature, the image text feature, and the audio text feature to obtain a text feature of the first text information.

7. The training method according to claim 5, wherein the performing the feature extraction and the fusion processing comprises:
concatenating the title text information, the image text information, and the audio text information to obtain concatenated text information of the video sample; and
performing feature extraction on the concatenated text information to obtain a text feature of the first text information.

8. The training method according to claim 1, wherein the generating the trained video time-effectiveness classification model comprises:
performing model training on an initial model based on the plurality of image features, the plurality of text features, and the plurality of time-effectiveness sensitivity features, to obtain a multi-modal pre-training model;
fusing, the plurality of video samples, the plurality of image features, the plurality of text features, and the plurality of time-effectiveness sensitivity features to obtain a plurality of multi-modal time-effectiveness features of the video sample; and
fine-tuning the multi-modal pre-training model based on the plurality of multi-modal time-effectiveness features, to obtain the trained video time-effectiveness classification model.

9. The training method according to claim 8, wherein the performing the model training on the initial model comprises:
determining a plurality of pre-training tasks, wherein at least one of the plurality of image features, the plurality of text features, or the plurality of time-effectiveness sensitivity features are used in a model training process of the plurality of pre-training tasks;
performing model training on the initial model based on the plurality of pre-training tasks, to determine a plurality of task losses of the plurality of pre-training tasks; and
obtaining the multi-modal pre-training model corresponding to the initial model based on a pre-training loss determined according to the plurality of task losses satisfying a convergence condition.

10. The training method according to claim 9, wherein the plurality of pre-training tasks comprise an image mask task for the plurality of image features, a text mask task for the first text information, and a binary classification task, and
wherein the performing the model training on the initial model comprises:
performing image mask task training on the initial model by performing mask self-encoding processing on a part of an image feature, and determining an image mask task loss of the initial model;
performing text mask task training on the initial model by performing mask self-encoding processing on a part of the first text information corresponding to a text feature, and determining a text mask task loss of the initial model; and
performing binary classification task training on the initial model based on a multi-modal time-effectiveness feature of the video sample obtained by fusing the image feature, the text feature, and a time-effectiveness feature with a binary classification tag of the video sample, and determining a binary classification task loss of the initial model.

11. A training apparatus for a video time-effectiveness classification model, the apparatus comprising:
at least one memory configured to store computer program code; and
at least one processor configured to read the program code and operate as instructed by the program code, the program code comprising:
video sample obtaining code configured to cause at least one of the at least one processor to obtain a plurality of video samples;
sample information extraction code configured to cause at least one of the at least one processor to extract, from the plurality of video samples, a plurality of sample image frames, first text information, and time-effectiveness sensitivity information;
feature extraction code configured to cause at least one of the at least one processor to extract a plurality of image features from the plurality of sample image frames, a plurality of text features from the first text information, and a plurality of time-effectiveness sensitivity features of the time-effectiveness sensitivity information; and
model training code configured to cause at least one of the at least one processor to generate a trained video time-effectiveness classification model from an untrained neural network model by training the neural network model based on the plurality of image features, the plurality of text features, and the plurality of time-effectiveness sensitivity features, wherein the trained video time-effectiveness classification model is configured to receive a video sample as input and output a predicted effective life cycle classification result.

12. The training apparatus according to claim 11, wherein the sample information extraction code comprises information extraction code and time-effectiveness sensitivity information code,
wherein the information extraction code is configured to cause at least one of the at least one processor to extract image information, audio information, and second text information from the plurality of video samples, and
wherein the time-effectiveness sensitivity information code is configured to cause at least one of the at least one processor to determine the time-effectiveness sensitivity information in the video sample based on at least one of the image information, the audio information, or the second text information.

13. The training apparatus according to claim 12, wherein the time-effectiveness sensitivity information code is configured to cause at least one of the at least one processor to:
semantically split the second text information to obtain a plurality of subtexts from the second text information;
determine time-effectiveness text, from among the plurality of subtexts, wherein the time-effectiveness text corresponds to time-effectiveness sensitivity text; and
determine the time-effectiveness text as the time-effectiveness sensitivity information in the video sample.

14. The training apparatus according to claim 12, wherein the image information comprises an image frame switching frequency, and the audio information comprises an audio frequency, and
wherein the time-effectiveness sensitivity information code is configured to cause at least one of the at least one processor to determine the image frame switching frequency and the audio frequency as the time-effectiveness sensitivity information.

15. The training apparatus according to claim 11, wherein the first text information comprises title text information, image text information, and audio text information,
wherein the sample information extraction code is configured to cause at least one of the at least one processor to:
obtain set text lengths of the title text information, the image text information, and the audio text information, and a title text, an image text, and an audio text extracted from the video sample; and
truncate or pad the title text, the image text, and the audio text based on the set text lengths, to obtain the title text information, the image text information, and the audio text information of the video sample, and
wherein the feature extraction code is configured to cause at least one of the at least one processor to perform feature extraction and fusion processing on the title text information, the image text information, and the audio text information.

16. The training apparatus according to claim 15, wherein the feature extraction code is configured to cause at least one of the at least one processor to:
extract a title text feature of the title text information, an image text feature of the image text information, and an audio text feature of the audio text information; and
fuse the title text feature, the image text feature, and the audio text feature to obtain a text feature of the first text information.

17. The training apparatus according to claim 15, wherein the feature extraction code is configured to cause at least one of the at least one processor to:
concatenate the title text information, the image text information, and the audio text information to obtain concatenated text information of the video sample; and
perform feature extraction on the concatenated text information to obtain a text feature of the first text information.

18. The training apparatus according to claim 11, wherein the model training code is configured to cause at least one of the at least one processor to:
perform model training on an initial model based on the plurality of image features, the plurality of text features, and the plurality of time-effectiveness sensitivity features, to obtain a multi-modal pre-training model;
fuse, the plurality of video samples, the plurality of image features, the plurality of text features, and the plurality of time-effectiveness sensitivity features to obtain a plurality of multi-modal time-effectiveness features of the video sample; and
fine-tune the multi-modal pre-training model based on the plurality of multi-modal time-effectiveness features, to obtain the trained video time-effectiveness classification model.

19. The training apparatus according to claim 18, wherein the model training code is configured to cause at least one of the at least one processor to:
determine a plurality of pre-training tasks, wherein at least one of the plurality of image features, the plurality of text features, or the plurality of time-effectiveness sensitivity features are used in a model training process of the plurality of pre-training tasks;
perform model training on the initial model based on the plurality of pre-training tasks, to determine a plurality of task losses of the plurality of pre-training tasks; and
obtain the multi-modal pre-training model corresponding to the initial model based on a pre-training loss determined according to the plurality of task losses satisfying a convergence condition.

20. A non-transitory computer-readable storage medium, storing computer code which, when executed by at least one processor, causes the at least one processor to at least:
obtain a plurality of video samples;
extract, from the plurality of video samples, a plurality of sample image frames, first text information, and time-effectiveness sensitivity information;
extract a plurality of image features from the plurality of sample image frames, a plurality of text features from the first text information, and a plurality of time-effectiveness sensitivity features of the time-effectiveness sensitivity information; and
generate a trained video time-effectiveness classification model from an untrained neural network model by training the neural network model based on the plurality of image features, the plurality of text features, and the plurality of time-effectiveness sensitivity features, wherein the trained video time-effectiveness classification model is configured to receive a video sample as input and output a predicted effective life cycle classification result.
